(19) United States
(12) Patent Application Publication
(10) Pub. No.: US 2004/0007087 A1
(43) Pub. Date: Jan. 15, 2004

(54) Handlebar expansion sleeve/grip

(76) Inventor: Glenn P. Cummings, Brandon, FL (US)

Correspondence Address: DONALD W. MEEKER, PATENT AGENT, 924 EAST OCEAN FRONT, # E, NEWPORT BEACH, CA, 92661, US

(21) Appl. No.: 10/274,331

(22) Filed: Oct. 17, 2002

Related U.S. Application Data
(63) Continuation-in-part of application No. 10/196,819, filed on Jul. 15, 2002.

(51) Int. Cl. B62K 21/26

(52) U.S. Cl. 74/551.9

(57) ABSTRACT

A solid handlebar expansion sleeve expands and shapes any desired portion of the handlebars. A rider's control is increased by engaging the forearm muscles through the full use of the palm and the full length of the phalanxes of the fingers contacting the sleeve. The rider achieves a solid, full-fisted grasp, relying on the forearm muscles and avoiding wrist fatigue for an ergonomically healthier grip. A split sleeve with three recessed screws is formed of rigid, molded plastic, in an eccentric oval shape which has a larger-diameter rounded palm receiving portion on top, and, a smaller-diameter rounded phalanx receiving portion extending away from the handlebar along the bottom. Two flat sides between the rounded portions receive the phalanxes of the fingers, contacting the flat sides with the fingers in a V-shape. Additional finger bracing protrusions and rubberized coatings and sleeves create a handlebar expander grip.

### REFERENCES TO RELATED PATENT APPLICATIONS

The present invention is a continuation-in-part of application Ser. No. 10/196,819 filed Jul. 15, 2002.

### BACKGROUND OF THE INVENTION

1. Field of the Invention

This invention relates to handlebars and, in particular, to a handlebar extension which expands and shapes any desired portion of the handlebar to increase control by enabling the greater use of the forearm muscles for an ergonomically healthier grip, wherein covering the handlebar extension creates a handlebar expansion grip.

2. Description of the Prior Art

Many vehicles are built with handlebars as a means for steering and controlling the vehicle, including motorcycles, traditional scooters, bicycles, snow mobiles, jet skis, four wheelers such as ATV's, new Razor Scooters™ or Sea Scooter™, and any other type of on-road or off-road vehicle using handlebars. Also, many types of exercise equipment, such as exercise bikes, use handlebars as well some tools employing handlebars, such as jackhammers. Controlling vehicles can be very challenging, particularly at high speeds or in rough riding conditions. In order to keep control of them, it is important to be able to maintain a consistent firm grip of the handlebars during the duration of their use. In the case of exercise equipment, a consistent firm grip of the handlebars counters the body's exercise movements and helps maintain balance for a more effective workout.

Handlebars are generally constructed from rigid tubular metal that is difficult to grip because the diameter of the handlebar is too small compared with the size of the phalanxes of the fingers so that the fingers cannot completely encircle and firmly engage the small diameter handlebar.

While a number of attempts have been made to improve the ability to grip a handlebar, none really address the basic problem of accommodating the phalanxes of the fingers to enable a rider to get an ergonomically sound, solid, full-fisted grasp of the handlebar.

U.S. Pat. No. #4,522,083, issued Jun. 11, 1985 to Morgan, provides a handlebar grip for the drop portion of a racing bicycle handlebar. The grip includes a flexible elongated body for fitting over the handlebar. An enlarged palm and thumb cheek support member formed integrally with the elongated body having a wall that extends upward and outward over the elongated body. A vibration absorbing means is provided intermediate the wall and the elongated body for minimizing the transmission of vibration from the handlebar to the palm of the hand.

U.S. Pat. No. #4,380,093, issued Apr. 19, 1983 to Morgan, shows a bicycle handlebar grip that is adapted to fit over the “cross-over” and “turn-of-bar” segments of a racing bicycle handlebar. The grip is shaped to allow a comfortable hand grip in any of several positions. The grip also includes provisions for reducing transmission of vibration from the handlebar to the rider's hand, thus avoiding physical ailments such as “biker's nerve palsy”.

U.S. Pat. No. #5,146,809, issued Sep. 15, 1992 to Ruana, claims a method and apparatus for shaping bicycle handlebars utilizing contoured forms (24, 26 and 28) and tape (30, 32) is provided. The forms may be placed on the handlebars in accordance with the rider's needs and enclosed thereon by the tape. The forms may be contoured or molded to conform with the rider's hands and arms.

U.S. Pat. No. #4,964,192, issued Oct. 23, 1990 to Marui, describes a cushioned grip having a unitary tubular-shaped body portion with an asymmetrical off-center cross-sectional shape. The asymmetrical off-center shape provides increased cushioning on portions thereof while retaining a moderate sized circumference. The asymmetrical cross-sectional shape provides a first portion having a first thickness of cushioning material, a second portion having a second lower thickness of cushioning material and a third portion of further reduced thickness of cushioning material. The third portion of cushioning is provided with a flat surface to provide a positive and solid feel to the fingers while grabbing the grip. The center's curvature defined by the outside of the cross-sectional shape of the grip is displaced from the center of the inside portion which is generally circular and adapted to receive a hard round member such as a bicycle handlebar to be cushioned. The cushioning thickness may vary from a relatively small value at one end of the grip to a maximum in a central region and reducing again to a smaller thickness at the other end to provide a varying circumference for different size hands.

While some soft grips are made larger than the handlebar, they do not allow for a rigid grasp of the handlebar for the complete control of the vehicle being used. What is needed is a solid handlebar expander which will enlarge the size and alter the shape of the handlebar to accommodate the full use of the length of the phalanxes of the fingers encircling the handlebar.

### SUMMARY OF THE INVENTION

An object of the present invention is to provide a handlebar expander shaped and sized to accommodate the full use of the length of the phalanxes of the fingers when the hand encircles and firmly engages the handlebar for a solid, full-fisted grip of the handlebar.

Another object of the present invention is to provide a handlebar expander which can be placed adjustably on any desired portion of the handlebar to suit the usual gripping location of the rider.

Another object of the present invention is to provide a grip that enables the hand to assume a comfortable orientation that is less fatiguing than previous handlebar grips.

One more object of the present invention is to provide an ergonomically effective handlebar expander to enable a full grip utilizing the palm and phalanxes of the fingers contacting the gripped portion, so that the rider's forearm muscles play a major role in controlling and directing the vehicle, equipment or tool by the handlebars. The rider's wrists, therefore, do not encounter the same stresses normally associated with gripping a handlebar.

Another corollary object of the present invention is that recessed screws avoid gripping discomfort, providing a smooth encountered surface.

An additional object of the present invention is that there is no need for additional parts, such as wrapping tape, to accompany the application of the handlebar grips.

A subsequent object of the present invention is that the handlebar grip expanders may be manufactured in a range of sizes for a better custom fit which will maintain the ability for users to have a solid, full-fisted grip.

A corollary object of the present invention is to provide handlebar expansion sleeves with rounded protrusions on a bottom edge to create finger braces to enhance the grip, wherein any number of rounded extensions may be formed, with just end protrusions or with several protrusions having convex spaces between to receive the fingers between the protrusions.

An extra object of the present invention is to allow a conventional rubberized hand grip to be stretched over the handlebar expansion sleeve for further comfort and to serve as a handle bar expansion grip.

A related object of the present invention is to provide a handlebar expansion sleeve which is coated with a rubberized material to create a handlebar expansion grip.

One additional object of the present invention is to provide a recessed portion to receive the palm of the rider for greater comfort and control.

In brief, a split sleeve formed of rigid, molded plastic, with a series of three recessed screws, slides along a handlebar and is secured to the handlebar at a desired position. The ergonomic, eccentric, oval shape of the split sleeve forms a handlebar expansion sleeve has a larger-diameter rounded palm receiving portion on top, and, a smaller-diameter rounded phalanx receiving portion extending away from the handlebar along the bottom. The two flat sides between the rounded portions receive the phalanxes of the fingers, contacting the flat sides with the fingers in a V-shape. The first joint, found between the first two phalanxes extending from the hand, contacts the small rounded portion of the grip expander.

A round interior opening inside the larger rounded palm receiving portion encircles and engages the round handlebar. A slot along the length of the sleeve from the interior circular opening to the outside of the small rounded phalanx receiving portion forms a split sleeve. A series of three screws are inserted in recessed openings along one side of the slot and engage interior threaded openings in the other side of the slot to secure the sleeve on the handlebar.

The handlebar expansion sleeve enables a full, firm grip on the handlebar enabling the use of the forearm muscles for controlling and directing the handlebars to a greater extent than the smaller rounded shape of the handlebar which puts more strain on the wrist due to the inability for the phalanxes and palm to be in full contact with the round handlebar. A conventional rubberized hand grip may be stretched over the handlebar expansion sleeve for further comfort.

The handlebar expansion sleeve may have rounded protrusions on a bottom edge to create finger braces to enhance the grip, wherein any number of rounded extensions may be formed, with just end protrusions or with several protrusions having convex spaces between to receive the fingers between the protrusions. A form-fitting rubberized hand grip can be stretched over the handlebar expansion sleeve for further comfort and to serve as a handle bar expansion grip or alternately, the handlebar expansion sleeve may be coated with a rubberized material by dipping or other means to create a handlebar expansion grip.

An advantage of the present invention is to provide a handlebar expander shaped and sized to accommodate the full use of the length of the phalanxes of the fingers.

Another advantage of the present invention is to provide a handlebar expander which can be placed adjustably on any desired portion of the handlebar to suit the usual gripping location of the rider.

An additional advantage of the present invention is to provide a grip that enables the hand to assume a comfortable orientation that is less fatiguing than previous handlebar grips.

One more advantage of the present invention is to provide an ergonomically effective handlebar expander.

Yet another advantage of the present invention is that the recessed screws avoid gripping discomfort, providing a smooth encountered surface.

Still another advantage of the present invention is that there is no need for additional parts, such as wrapping tape, to accompany the application of the handlebar grips.

An ensuing advantage of the present invention is that the handlebar grip extenders may be manufactured in a range of sizes for a better custom fit.

A practical advantage of the present invention is to allow a conventional rubberized hand grip to be stretched over the handlebar expansion sleeve for further comfort.

One more advantage of the present invention is that it can be formed into a handlebar expansion grip by having finger bracing protrusions and by coating or covering with a rubberized material.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the handlebar expansion sleeve of the invention secured to a handlebar adjacent to a central connecting portion of the handlebar;

FIG. 2 is a perspective view of the handlebar expansion sleeve secured to a handlebar adjacent to an end of the handlebar;

FIG. 3 is a side elevational view of the handlebar expansion sleeve showing the series of screws;

FIG. 4 is an end elevational view of the handlebar expansion sleeve showing the interior circular opening and interior slot forming the split sleeve;

FIG. 5 is a side elevational view of the handlebar expansion sleeve fitted with a conventional rubberized hand grip over the handlebar expansion sleeve;

FIG. 6 is a side elevational view of an alternate embodiment of the handlebar expansion sleeve having protrusions on the bottom acting as finger braces for all four fingers with concave spaces between to form a handlebar expansion grip;

FIG. 7 is a side elevational view of another alternate embodiment of the handlebar expansion sleeve having a single protrusion at one end and a pair of protrusions at the other end on the bottom for a finger brace with a concave space inbetween to form a handlebar expansion grip;

FIG. 8 is a side elevational view of another alternate embodiment of the handlebar expansion sleeve having a single protrusion at each on the bottom to maintain the hand thereon to form a handlebar expansion grip;

FIG. 9 is a side elevational view of the alternate embodiment of the handlebar expansion sleeve of FIG. 6 having a coating of rubberized material thereon to form a handlebar expansion grip;

FIG. 10 is a side elevational view of the alternate embodiment of the handlebar expansion sleeve of FIG. 6 having a form-fitting sleeve of rubberized material slid over the handlebar expansion sleeve to form a rubberized handlebar expansion grip.

### BEST MODE FOR CARRYING OUT THE INVENTION

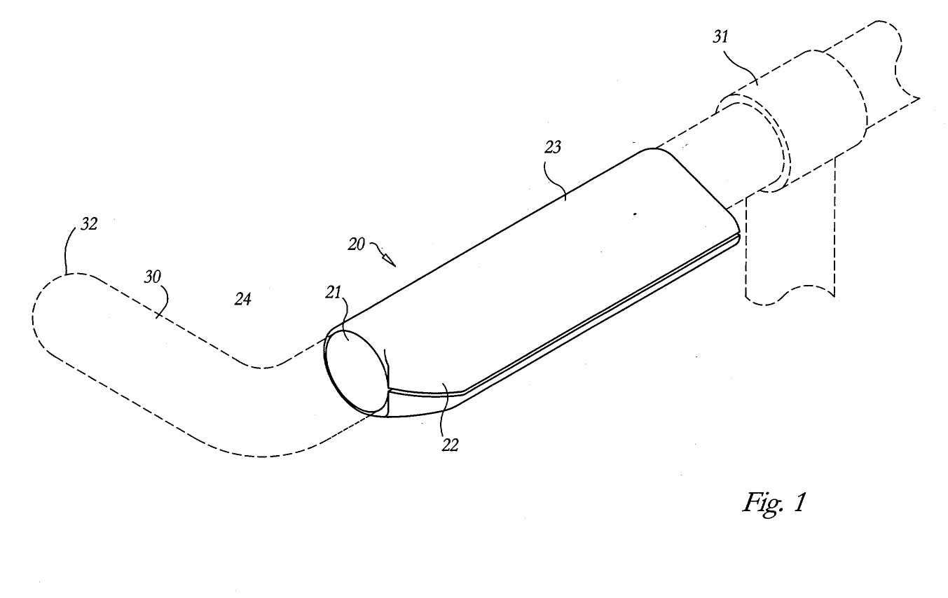

In FIGS. 1-10, a handlebar expander is adjustably positioned on a handlebar 30 providing a full-fisted grip around the handlebar 30 with the palm and phalanxes of the hand of the driver fully encircling, contacting, and engaging the handlebar expander. The handlebar expander is comprised of a handlebar expansion sleeve 20 and 20A-D fabricated of a rigid material capable of sliding onto a handlebar 30. It is rigidly secured to the handlebar 30 at a rider's desired position. The handlebar expansion sleeve 20 and 20A-D is configured to form a peripheral expansion of the handlebar 30 along a portion of the handlebar so that a hand of a driver encircles and engages the handlebar expansion sleeve 20 with the palm and the phalanxes of the fingers of the driver maintaining full contact with the handlebar expansion sleeve 20 in a secure grip supported by the forearm muscles of the driver.

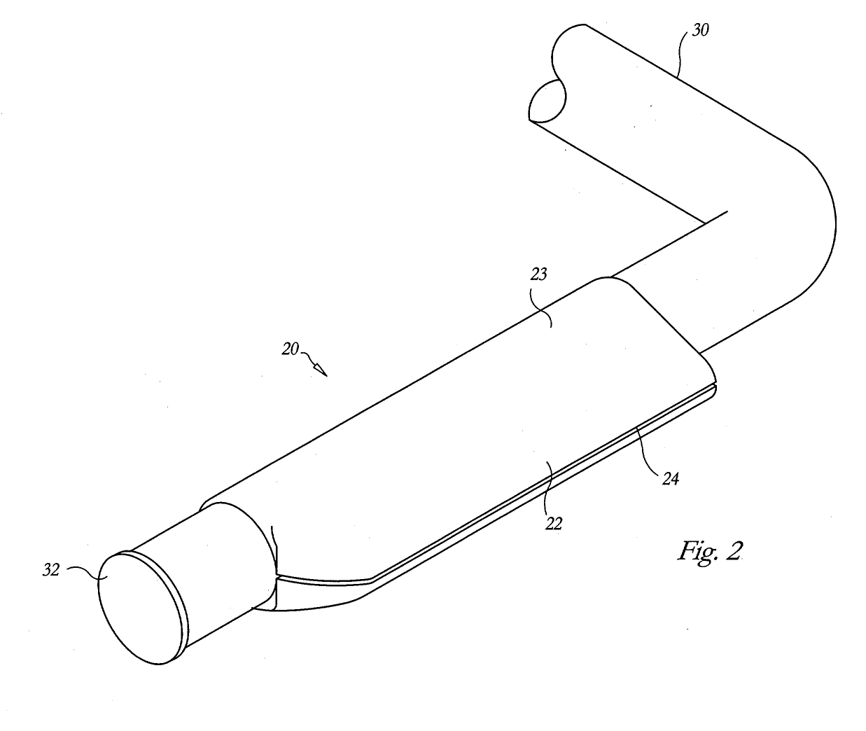

In FIGS. 1-2, there is an adjustable means, being a series of screws 25 closing a slot 24, for securing the handlebar expansion sleeve 20 to the handlebar 30 so that the handlebar expansion sleeve 20 is capable of alternating between a sliding configuration, for sliding along the length of the handlebar to a desired position on the handlebar, and a secured position with the handlebar expansion sleeve 20 securely engaging the handlebar 30 making it capable of being controlled.

In FIGS. 1-5, the handlebar expansion sleeve 20 is comprised of a split sleeve which has a slot 24 along one edge and a series of screws 25 forming an adjustable means for securing the handlebar expansion sleeve 20. The fasteners 25 are inset in recessed openings 26 in the split sleeve, out of contact with the hand of the driver.

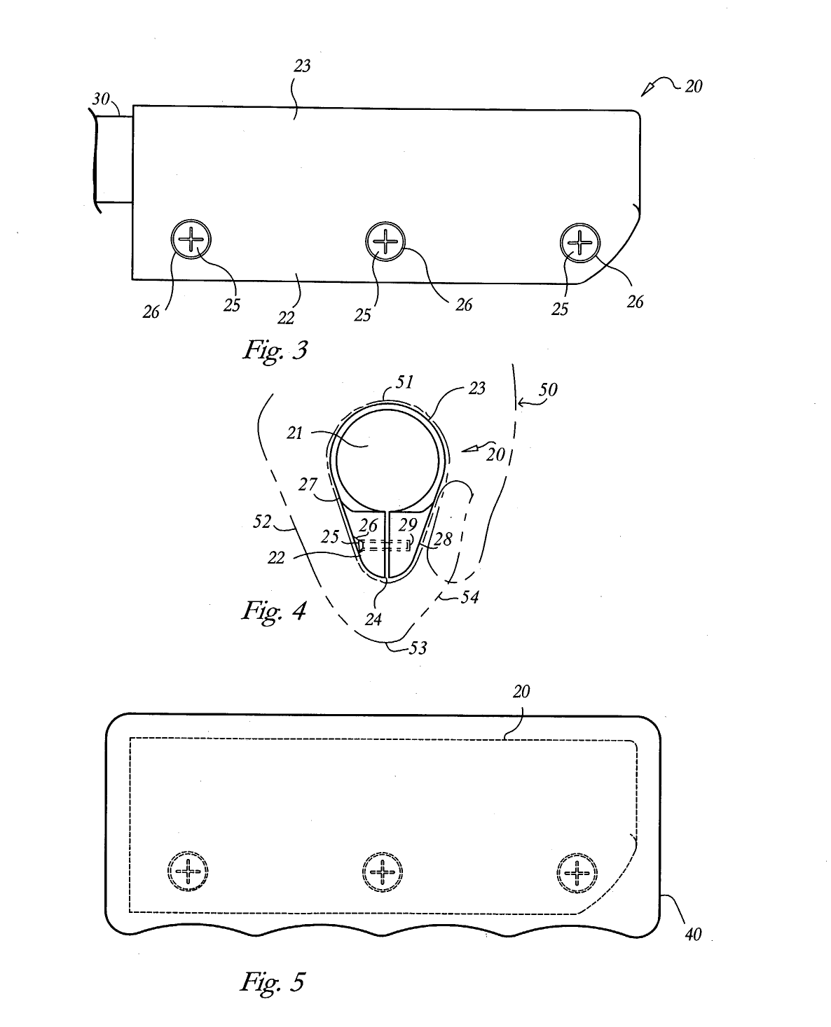

In FIGS. 3-5, the series of fasteners 25 is comprised of at least two, preferably three, screw means 25 inset in recessed openings 26 on one side of the slot 24 along the length of the split sleeve and screwed into threaded openings 29 on the other side of the slot 24. The threaded openings 29 are internal and do not extend to the flat surface 28 on the opposite side.

In FIG. 4, the handlebar expansion sleeve 20 has an ergonomic, eccentric, ovular cross-sectional shape along its length with a larger-diameter palm engaging portion 23 and a smaller-diameter phalanx engaging portion 22 and a flat portion 27, 28 on each side therebetween. The palm engaging portion 23 and the phalanx engaging portion 22 are separated by a distance equal to the length of the first phalanx 52 of the hand of the driver, so that the palm engaging portion 23 is capable of receiving a palm 51 of the driver in full contact with the palm engaging portion 23. The phalanx engaging portions 27, 28 are capable of receiving the fingers of the rider with the phalanxes 52, 54 in full contact with the flat portions 27, 28 respectively, and furthermore, with the first phalanx joint 53 contacting the rounded edge at the opening of the slot 24 of the phalanx receiving portion 22.

In FIG. 4, the palm engaging portion 23 has an interior circular opening 21 along the length of the handlebar expansion sleeve 20. The circular opening 21 is capable of encircling and engaging a handlebar 30. The phalanx engaging portion 22 has an interior slot 24 along the length of the handlebar expansion sleeve 20. The interior slot 24 runs from the circular opening 21 to an exterior edge of the phalanx receiving portion 22 to form a split sleeve

In FIGS. 3-5, the handlebar expander is further comprised of at least two spaced openings 26, preferably three, recessed below the surface of the handlebar expansion sleeve 20 on one side 27 of the interior slot 24 and a threaded interior opening on the other side 28 of the interior slot 24 so that a screw means 25 may be inserted in each of the spaced openings 26 to secure the handlebar expansion sleeve 20 to the handlebar 30.

In FIG. 5, the handlebar expansion sleeve 20 is fitted with a conventional rubberized hand grip 40 over the handlebar expansion sleeve 20 to form a high friction handlebar expander grip.

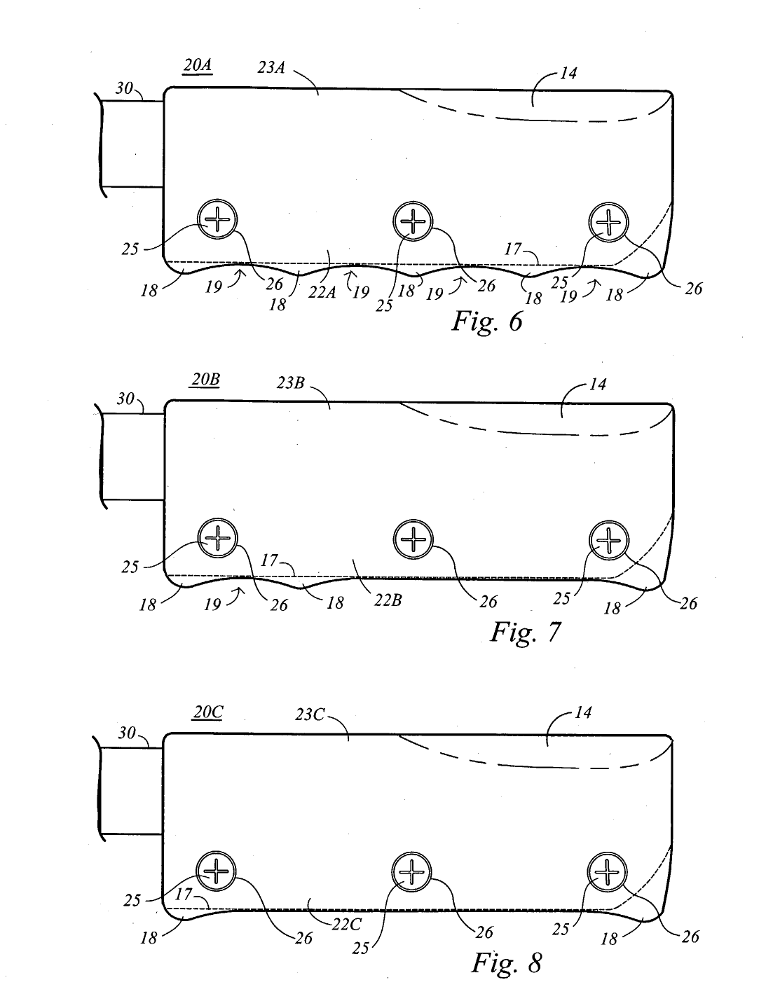

In FIGS. 6-8, the handlebar expansion sleeve further comprises finger engaging protrusions 18 extending from the edge 17 (shown dashed) of the phalanx receiving portion 22A-22C. In FIG. 6, a series of finger engaging protrusions 18 extend from the edge 17 (shown dashed) of the phalanx receiving portion 22A of the handlebar expansion sleeve 20A spaced apart with concave surfaces 19 therebetween to admit the fingers of the hand to form a handlebar expander grip.

In FIG. 7, the handlebar expansion sleeve 20B comprises a first finger engaging protrusion 18 at each end and a second interior finger engaging protrusion 18 spaced apart from one end to form a pair of finger engaging protrusions at that end spaced apart to admit a finger therebetween on a concave surface 19, all finger engaging protrusions 18 extending from the edge 17 (shown dashed) of the phalanx receiving portion 22B, to form a handlebar expander grip.

In FIG. 8, the handlebar expansion sleeve 20C has a single finger engaging protrusion 18 extending from the edge 17 (shown dashed) of the phalanx receiving portion 22C at each end to prevent the hand from slipping off, thereby forming a handlebar expander grip.

In FIGS. 6-8, the handlebar expansion sleeve 20A-C may further be provided with a recessed portion 14 defined by the dashed line on the palm receiving portion 23A-C to receive the palm of the rider for greater comfort and control.

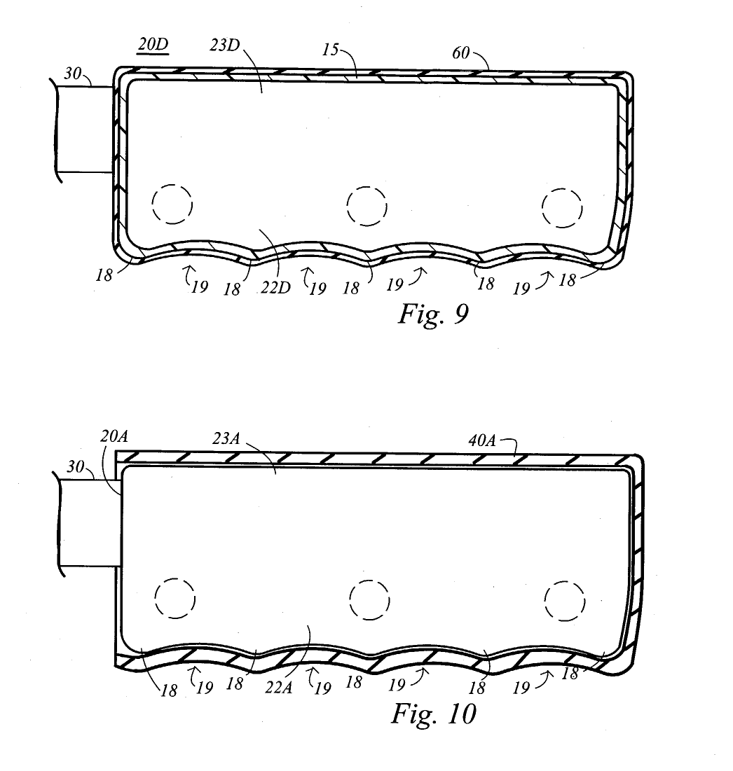

In FIG. 9 the handlebar expansion sleeve 20D similar to that of FIG. 6 with a series of spaced apart finger protrusions 18 further comprises a rubberized coating 60 over an exterior surface of the handlebar expander to form a high friction handlebar expander grip. Any of the embodiments of the handlebar expansion sleeve could be coated with a rubberized surface to form a high friction handlebar expander grip.

In FIG. 10 the handlebar expansion sleeve 20A of FIG. 6 further comprises a rubberized sleeve 40A formed to fit over an exterior surface of the handlebar expander to form a high friction handlebar expander grip.

The expansion sleeve is preferably formed of hard molded plastic, but may also be formed of metal or other firm graspable material for good control. If desired the handlebar expander may be formed as a built-in portion of the handlebar.

It is understood that the preceding description is given merely by way of illustration and not in limitation of the invention and that various modifications may be made thereto without departing from the spirit of the invention as claimed.

What is claimed is:

1. A handlebar expander adjustably positionable on a handlebar providing a full-fisted grip around the handlebar with the palm and phalanxes of the hand of the driver fully engaging the handlebar expander, the handlebar expander comprising:
a handlebar expansion sleeve fabricated of a rigid material capable of sliding onto a handlebar and being rigidly secured to the handlebar at a desired position on the handlebar, the handlebar expansion sleeve configured to form a peripheral expansion of the handlebar along a portion of the handlebar so that a hand of a driver encircles and engages the handlebar expansion sleeve with the palm and the phalanxes of the fingers of the driver maintaining full contact with the handlebar expansion sleeve in a secure grip supported by the forearm muscles of the driver;
an adjustable means for securing the handlebar expansion sleeve to the handlebar so that the handlebar expansion sleeve is capable of alternating between a sliding configuration for sliding along the length of the handlebar to a desired position on the handlebar and a secured position with the handlebar expansion sleeve securely engaging the handlebar and capable of controlling the handlebar.

2. The handlebar expander of claim 1 wherein the handlebar expansion sleeve comprises a split sleeve and the adjustable means for securing the handlebar expansion sleeve comprises a series of fasteners for closing the slit, the fasteners inset in the split sleeve out of contact with the hand of the driver.

3. The handlebar expander of claim 2 wherein the series of fasteners comprise at least two screw means inset in recessed threaded openings along the length of the split sleeve.

4. The handlebar expander of claim 1 wherein the handlebar expansion sleeve has an eccentric ovular cross-sectional shape along its length with a larger diameter palm engaging portion and a smaller diameter phalanx engaging portion and a flat portion on each side therebetween, the palm engaging portion and the phalanx engaging portion separated by a distance between the thumb/hand joint and the first phalanx joint of the hand of the driver so that the palm engaging portion is capable of receiving a palm of the driver in full contact with the palm engaging portion and the phalanx engaging portion is capable of receiving the fingers of the rider with the phalanxes in full contact with the flat portions and the first phalanx joint contacting the phalanx receiving portion.

5. The handlebar expander of claim 4 wherein the palm engaging portion has an interior circular opening along the length of the handlebar expansion sleeve, the circular opening capable of encircling and engaging a handlebar and the phalanx engaging portion has an interior slot along the length of the handlebar expansion sleeve, the interior slot running from the circular opening to an exterior edge of the phalanx receiving portion to form a split sleeve.

6. The handlebar expander of claim 5 further comprising at least two spaced openings recessed below the surface of the handlebar expansion sleeve on one side of the interior slot and a threaded interior opening on the other side of the interior slot so that a screw means may be inserted in each of the spaced openings to secure the handlebar expansion sleeve to the handlebar.

7. The handlebar expander of claim 4 further comprising a first finger engaging protrusion extending from at least one end of the phalanx receiving portion to form a handlebar expander grip.

8. The handlebar expander of claim 7 further comprising at least one second finger engaging protrusion extending from the phalanx receiving portion spaced apart from the first finger engaging protrusion to admit a finger therebetween to form a handlebar expander grip.

9. The handlebar expander of claim 4 further comprising a series of finger engaging protrusions extending from the phalanx receiving portion spaced apart to admit the fingers of the hand therebetween to form a handlebar expander grip.

10. The handlebar expander of claim 4 further comprising a rubberized coating over an exterior surface of the handlebar expansion sleeve to form a high friction handlebar expander grip.

11. The handlebar expander of claim 4 further comprising a rubberized sleeve formed to fit over an exterior surface of the handlebar expansion sleeve to form a high friction handlebar expander grip.

12. The handlebar expander of claim 4 further comprising a recessed portion of the palm receiving portion.

13. The handlebar expander of claim 1 wherein the expansion sleeve is formed of hard molded plastic.

14. The handlebar expander of claim 1 wherein the expansion sleeve is formed of metal.

15. The handlebar expander of claim 1 wherein the handlebar expander is formed as a built-in portion of the handlebar.
